(19) United States
(12) Patent Application Publication
(10) Pub. No.: US 2010/0184340 A1
(43) Pub. Date: Jul. 22, 2010

(54) CRIMPABLE CONNECTOR CONTACT ASSEMBLY FOR CABLE CONNECTOR, CABLE CONNECTOR AND METHOD FOR MANUFACTURING THEREOF

(76) Inventors: Bernardus Paagman, Schijndel (NL); Ludwig Lange, Nuland (NL)

Correspondence Address: HARRINGTON & SMITH, 4 RESEARCH DRIVE, Suite 202, SHELTON, CT, 06484-6212, US

(21) Appl. No.: 12/452,922

(22) PCT Filed: Jul. 30, 2007
(86) PCT No.: PCT/IB2007/003247

§ 371 Date: Mar. 29, 2010

(51) Int. Cl. H01R 43/00; H01R 4/18

(52) U.S. Cl. 439/882; 29/700; 29/874

(57) ABSTRACT

A connector contact assembly is provided, which includes a contact part for establishing electrical contact between a conductor of a cable or wire and a mating counter contact. The contact part includes a mating section and a crimping section, the crimping section includes a plurality of contact beams extending from the mating section and being arranged for engaging the conductor of the cable or the wire. The assembly further includes a crimping ferrule being adapted to be crimped onto at least a portion of the contact beams for fixing the contact part to the conductor.

### FIELD OF THE INVENTION

The present invention relates to the field of electrical connectors and contacts for such connectors. More particularly, the invention relates to cable connectors designed and configured for transmitting power and connector contacts for such connectors.

### BACKGROUND OF THE INVENTION

Electrical connectors, especially electrical connectors designed and configured for transmitting power may have to meet competing and sometimes conflicting demands, e.g. relatively high power transfer, small size, close and stable packing of contacts in a single connector housing and the prevention of heat build-up, such as due to resistive losses. Especially for high currents, such as several tens of Amperes, e.g. ca. 50 A or more, small electrical resistances may cause high temperatures. The increased electrical resistivity of most materials with increasing temperature, e.g. 4% per 10° C. for copper, aggravates this problem.

Further, the design of typical power connectors and contacts therefore may give rise to relatively high mating forces of several Newton per individual contact.

With cable connectors, it may happen that the connection is unmated by pulling on the cable, instead of on the connector or on the contact.

A cable connector for transmitting power should thus be compatible with such dimensional, thermal and mechanical constraints. Preferably, a connector should stand prolonged use (on the order of several years) and not suffer aging effects, such as increasing resistance.

From EP 373 675 an electrical terminal is known which is stamped and formed from a single thickness of metal stock and comprises a hollow body portion and a plurality of contact sections extending forwardly therefrom, first and second opposing transition portions, and a double layer barrel portion. The transition portions coextend rearwardly from respective opposing side sections of the hollow body portion. The double layer barrel portion includes first and second barrel sections which extend rearwardly from the respective first and second transition portions.

An electrical contact is known comprising a mating portion capable of receiving a counter contact and a clamping portion capable of attaching said contact to a wire. The clamping portion comprises at least a first wire clamping beam and a second wire clamping beam, the first and second wire clamping beams separately extend from said mating portion.

However, producing a contact with such an integrated crimping section according to the prior art sets high requirements to the construction of the contact, e.g. forming a barrel portion from a stamped blank sheet may require the use of intricate forming dies and/or mandrels. This complicates manufacture of the contact.

Moreover, it has been found that the holding force of such clamping fingers or barrel portions may be insufficient for establishing a contact resistance that is acceptably low for a high current power contact. The relatively high contact resistance of such prior art connectors may lead to a too high temperature of the contact which weakens the material of the clamping fingers. This self-enhancing effect may deteriorate the contact further and may even cause the crimped contact to fail, both electrically and mechanically.

A way to prevent the relaxing and loosening of the contact is by brazing of the seam between the clamping fingers to close off the barrel portion. However, this requires high temperatures which adversely affect the mechanical and electrical properties of the contact. Brazing further renders the manufacturing of the contact even more complex.

Consequently, there is a need for an improved connector and a contact therefor which may alleviate shortcomings of the prior art.

### SUMMARY OF THE INVENTION

In one aspect, this invention is a connector contact assembly according to claim 1.

Such a connector contact assembly allows to independently form and optimise the contact part and the crimping ferrule, e.g. with respect to the design of the mating section, the material properties and/or the fabrication.

A crimping section formed as a plurality of contact beams allows increasing the cross section of the current carrying material relative to a single base beam. This reduces the total resistance of the contact and the current density therein resulting in a reduced power dissipation and, consequently, lower temperature. It also allows increasing the surface area of the contact relative to one having a single contact beam, or base, for more efficient convective cooling.

Further, having a plurality of contact beams may remove a structural weak point of a contact with a single contact beam.

The ferrule may be manufactured from tubular material, e.g. a metal tube, which substantially prevents relaxing and subsequent loosening of the connection. Thus reliability of the connection is improved and aging effects may be prevented.

The embodiment according to claim 2 allows a proper matching of the crimping section to the conductor size, e.g. the barrel just fitting around and/or enveloping the conductor. A barrel shape maximises the available cross section of the current carrying material of the contact and maintains optimum mechanical and electrical contact between the contact beams and the conductor.

The crimping section may comprise one or more interior ribs for improving engagement of the contact with the conductor onto which it is crimped, as the ribs “bite” into the conductor material. This causes an increased effective contact surface, thus reducing the electrical contact resistance and increasing both the mechanical strength of the connection and the thermal contact between the contact and the conductor, which may serve as a heat sink. The mechanical holding strength is improved by arranging the ribs circumferentially. Further, pressing ribs into a conductor may locally destroy a present oxide-layer, which is generally poorly conductive or even insulating, thus further improving the connection.

Although the mating section may have any desired shape, it is preferably formed from foldable or folded plate- or sheet like material, as defined in claim 3. This allows the contact to be manufactured at relatively low cost.

The embodiment of claim 4 provides an

connector contact having a mating section with a design providing relatively low mating force to an appropriate counter-contact.

The embodiment of claim 5 improves the mechanical properties of the contact. It prevents a constriction in the cross section of the cables and connector part between the crimping section and the insulated portion of the cable or wire. Such constriction otherwise forms a preferred location for bending which may easily lead to damaging of the cable or the conductor. Furthermore, in case of a multi-strand conductor, the relatively fragile single strands remain protected from direct access. Crimping the ferrule onto the insulation also assists maintaining the insulation in place, in case pull is exerted thereon.

In another aspect, the invention is a connector contact assembly according to claim 6.

Thus, a connector contact assembly is provided of which the contact part may be manufactured efficiently and at relatively low cost from a plate, e.g. a cut or stamped blank, by folding and which allows minimizing the current density throughout the contact and the contact-to-wire connection. At the same time, the contact part may be fixed to the conductor of a cable or a wire reliably and with relatively low contact resistance. The resultant connector contact may be used for transmitting relatively high powers without excessive heating and may be relatively mechanically robust.

In yet another aspect, the invention is a connector contact assembly according to claim 7.

Thus a connector contact assembly is provided which is suitable for sustaining high power transmission for prolonged duration, having relatively low contact resistance while causing only relatively low mating force. The connector contact is adapted to be fixed to the conductor of a cable or wire by crimping with relatively low contact resistance. The connector contact assembly provides relatively good prevention against detrimental aging effects.

In accordance with the above-mentioned considerations, the invention is also directed to a method for attaching a connector contact assembly to onto a conductor of a cable or a wire according to claim 10.

Thus, a cable connector which is suitable for transporting relatively high currents may be assembled relatively efficiently. The exposed portion of the conductor and the contact beams may advantageously engage each other, in particular already before crimping the ferrule, to optimise the contact surface and obtain a relatively low contact resistance.

The connector contact assemblies, the method discussed above and various aspects thereof will be explained in more detail with reference to the figures, which show an embodiment by way of example only.

### BRIEF DESCRIPTION OF THE DRAWINGS

FIGS. 1A-1C show different views of an embodiment of a contact part of a connector contact assembly.

FIGS. 2A and 2B show different embodiments of a contact part of a connector contact assembly.

FIGS. 3A-3D show different stages of assembling a connector contact assembly and fixing it to a cable.

FIG. 4 shows a cross section in the plane IV-IV of the assembled connector contact of FIG. 3C after crimping the ferrule.

FIG. 5 shows a schematic view of the plane V-V indicated in FIG. 4 of the assembled connector contact of FIG. 3C prior to crimping the ferrule.

FIGS. 6A and 6B show views similar to that of FIG. 5 of embodiments of contact assemblies with the contact parts shown in FIGS. 2A and 2B, respectively.

### DETAILED DESCRIPTION OF THE DRAWINGS

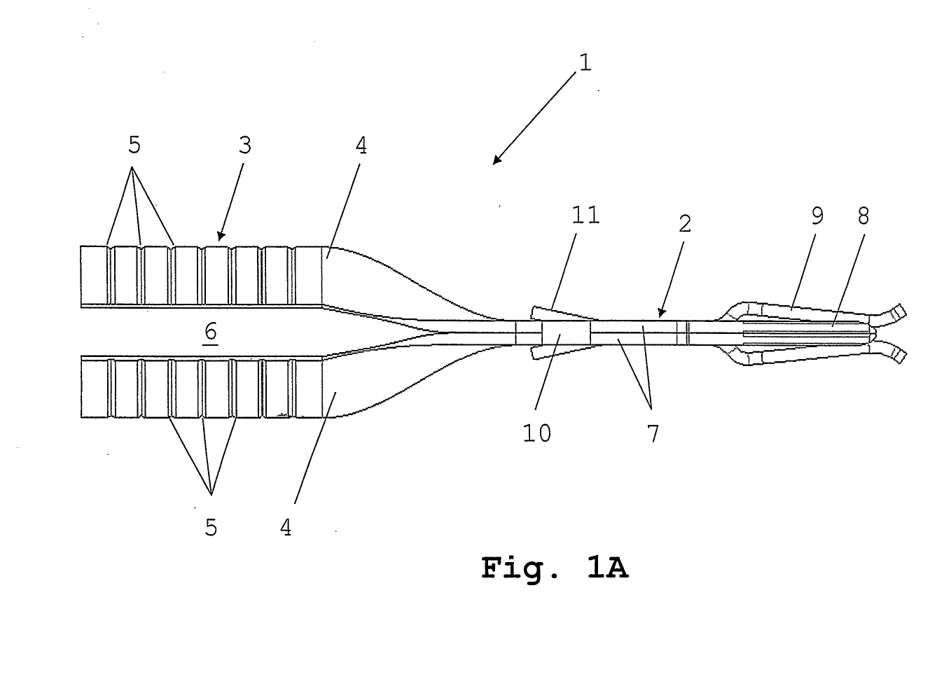

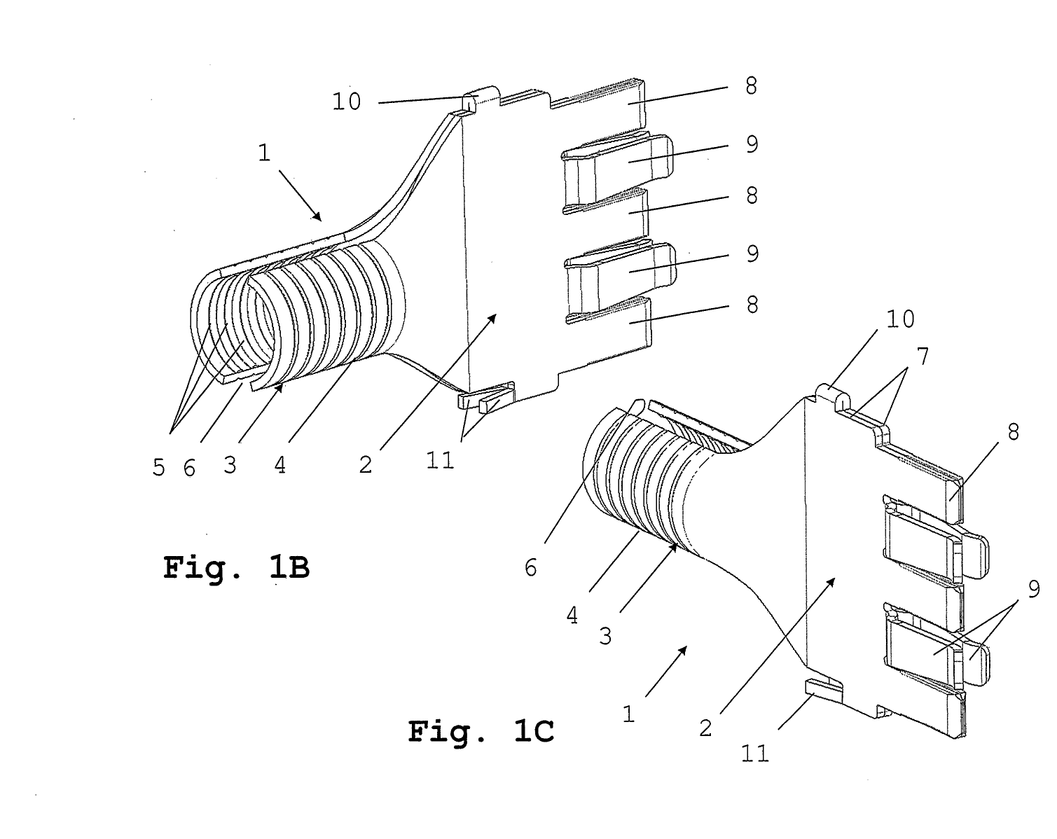

The connector contact assembly comprises a contact part and a crimping ferrule. The contact part 1, as shown in FIGS. 1A-1C, comprises a mating section 2 and a crimping section 3. The crimping section 3 is generally barrel shaped and is formed as two contact beams 4 extending from the mating section 2. The contact beams 4 are provided with substantially circumferential interior ribs 5 (of which three are indicated). The contact beams 4 are separated by gaps 6.

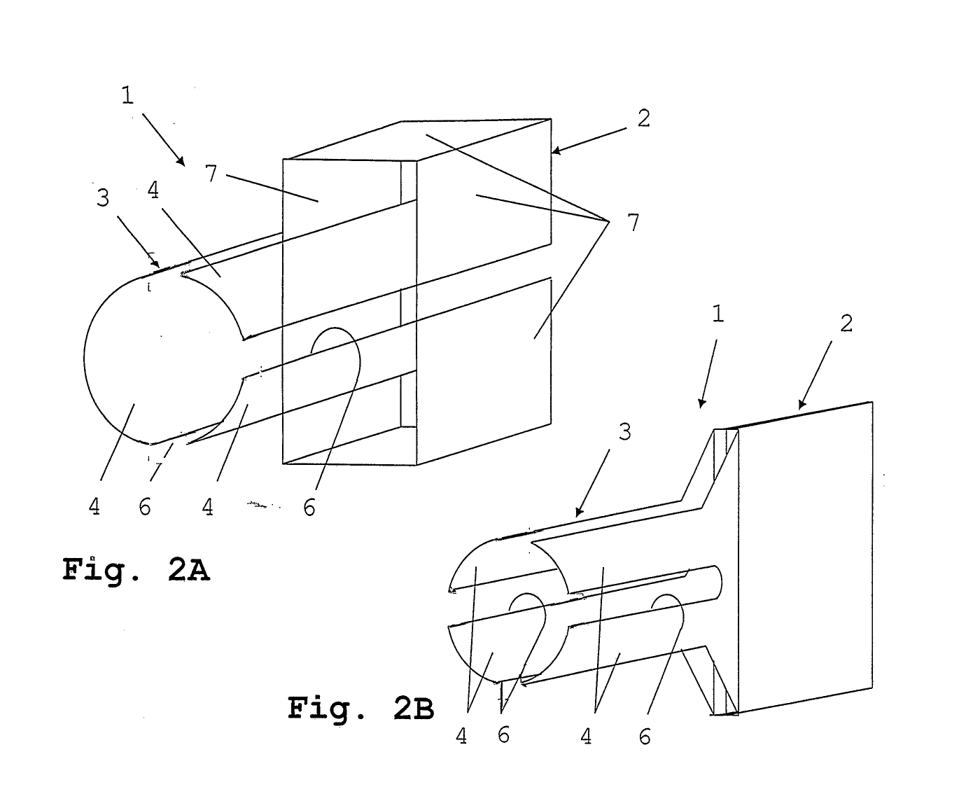

FIGS. 2A and 2B show schematic views of contact parts having three and four contact beams, respectively.

The mating section 2 comprises two plate-like body members 7 stacked against each other. A plurality of straight or flat beams 8 and a plurality of bent or angled beams 9 alternatingly extending from each of the body members 7. A mating section 2 of such design combines a relatively low mating force with a relatively low contact resistance. However, different designs for mating section 2 are equally conceivable, as indicated by FIGS. 2A and 2B.

The contact part 1 of this embodiment is formed from stamped or cut sheet-like conductive material, such as copper or phosphor-bronze, and may be gold-plated. The cut material is pre-formed and folded about folding area 10. The mating section 1 is further provided with retention features 11 for retaining the connector contact in a housing (not shown).

In the embodiment of FIG. 2A, the plate-like body members 7 define a hollow contact part 2.

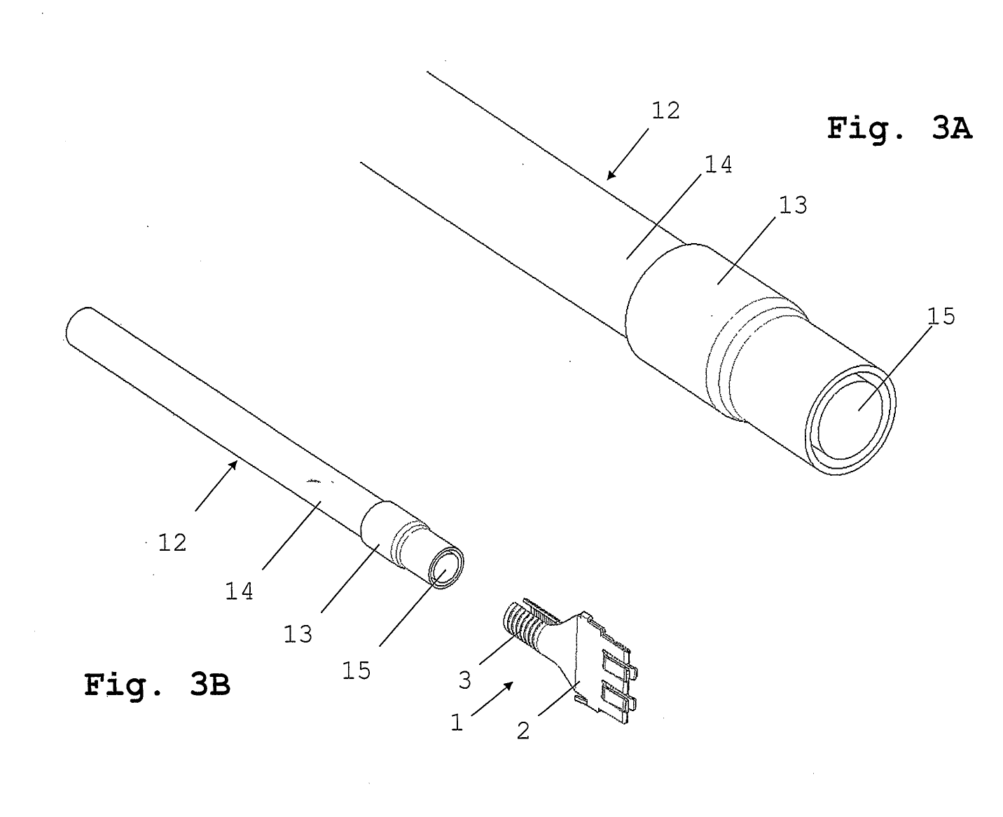

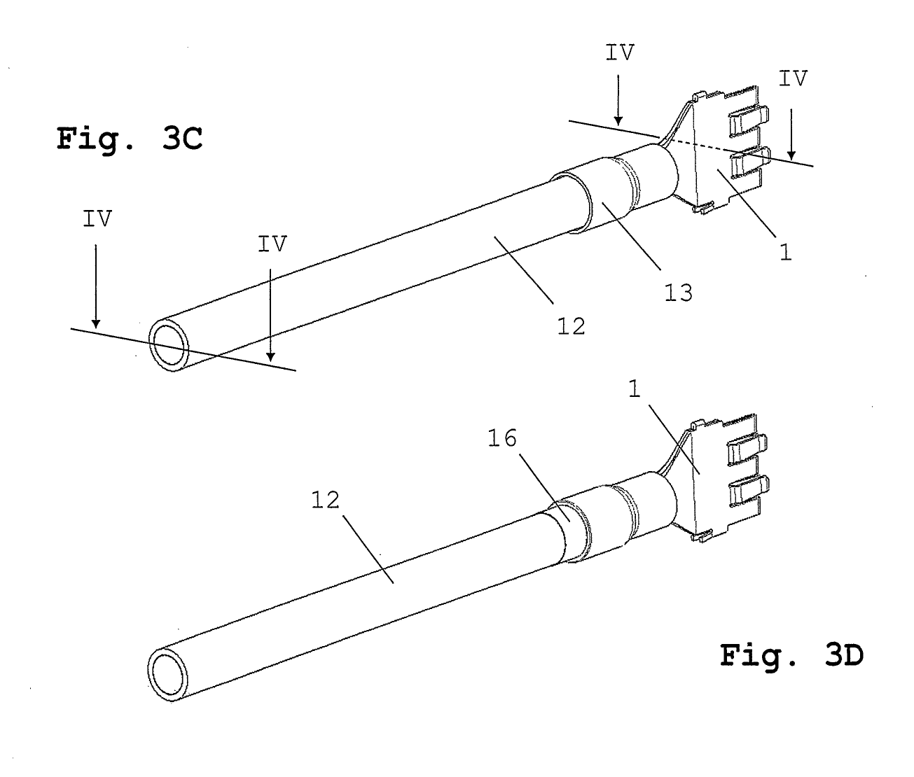

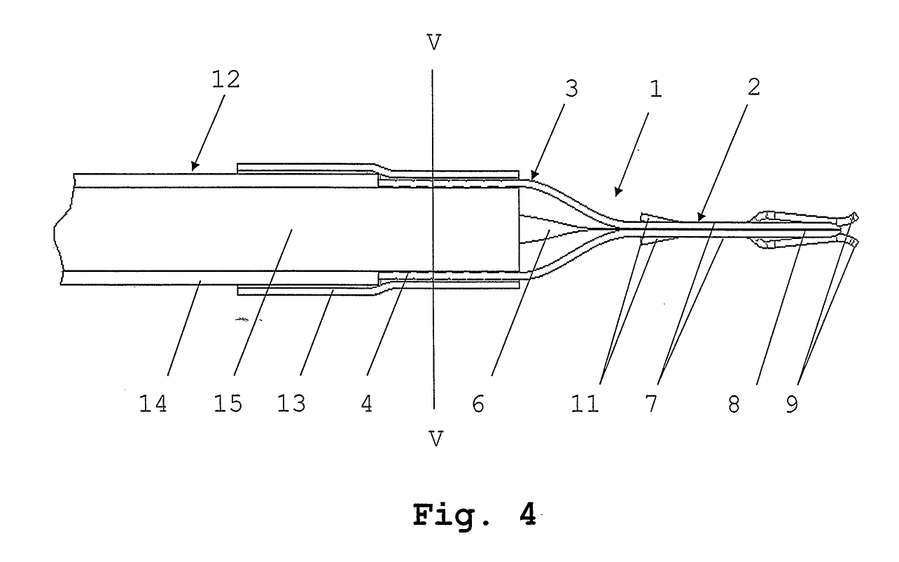

A method for attaching a connector contact assembly to a cable will be explained with reference to FIGS. 3A-3D.

FIG. 3A shows an insulated cable 12 surrounded by a crimping ferrule 13 which forms part of the connector contact assembly. The crimping ferrule may be of any suitable material, however, for optimising the mechanical and conductive properties of the connection, the crimping ferrule 13 may be metallic.

In a first step of the method, the insulating sheath 14 of the cable 12 is stripped over a portion of the cable length, exposing the conductor 15. Next, the crimping ferrule 13 is arranged around the cable 12 (FIG. 3A), e.g. by threading onto the cable 12 from one end thereof.

In FIG. 3A-3D the ferrule 13 is arranged around the exposed conductor 15 and partly over the remaining insulating sheath 14. Here, the ends of the ferrule 13 and of the conductor 15 may lie substantially in a plane. The shown ferrule 13 has a portion with a relatively large diameter for overlapping the insulating sheath 14 and a portion with a relatively small diameter fitting the crimping barrel and the conductor. A ferrule 13 with a substantially continuous diameter may also be used, e.g., when the ferrule 13 does not envelop the insulating sheath 14, or in case the insulating sheath 14 and the crimping section 3 have substantially equal thicknesses.

Next, a crimping section 3 of a contact part 1 is arranged at least partially inside the ferrule 13 (FIGS. 3B, 3C), here by inserting the crimping section 3 into the free space delimited between the inner wall surface of the ferrule 13 and the conductor(s). Then the ferrule 13 is crimped onto the conductor 15 and the crimping section 3, thereby fixing the conductor 15 and the contact part 2 mechanically and electrically to each other.

As an alternative, the crimping section 3 may be first arranged to engage the exposed conductor 15, next the ferrule 13 is arranged around the crimping section 3 and the conductor 15 and then the ferrule 13 is crimped at least onto the exposed conductor portion. The ferrule 13 may be placed around the cable 12 before arranging the contact part 1. The inside edge corners of the ferrule 13 and/or the crimping section 3 may be chamfered or filleted for easier threading and mounting.

The ribs 5 on the inside wall of the crimping section 3 may also form a screw thread or several interspersed screw threads, allowing the contact part 1 to be screwed onto the conductor 15 for better fixation and/or contact. The ferrule 13 then serves to secure the connection as described above.

As shown in FIG. 3D, the attached connector contact assembly may be covered at least partially, e.g. by shrinkable or crimpable insulation tubing 16, for electrical insulation and/or mechanical reinforcement. Also, the ferrule 13 itself may be insulating, e.g. by having a portion covered with an insulating material or by being made of an insulating material.

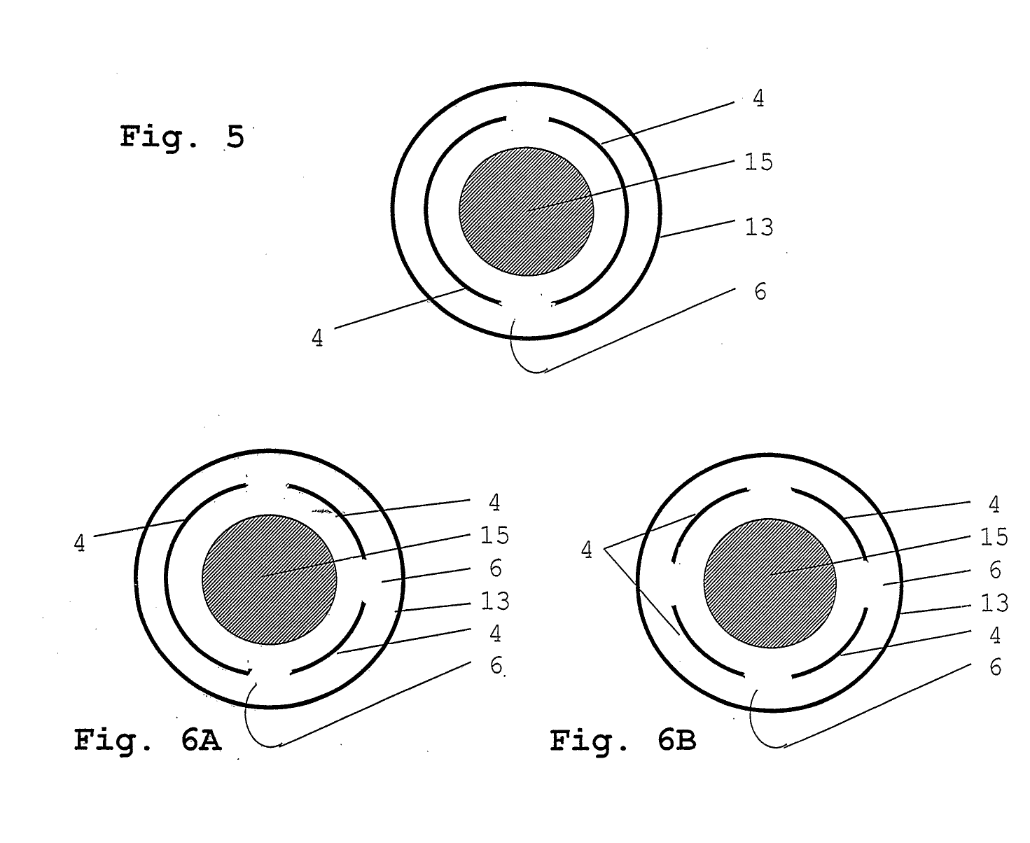

Although it is not required that the ferrule 13 is conductive, it is preferred that the contact beams 4 engage the conductor 15. The contact beams 4 of the crimping section 3 may be arranged between the ferrule inner wall and the conductor 15, as shown in FIGS. 5-6B, before and after crimping the ferrule 13, respectively. This allows increasing the cross sectional size of the contact beams 4, and thus reduce their electrical resistance. The number of contact beams 4 may be varied, as shown by the different embodiments. A symmetrical arrangement of the beams 4 (FIGS. 5, 6B) is thought to provide optimum crimping and holding. The gaps 6 between the contact beams 4 (only some of which are identified in the figures) allow the contact part 1 to be used for a range of different conductor sizes. Gaps 6 may also improve convective cooling of the contact assembly.

The conductor 15 may be a single conductor or be composed of a plurality of wires. The latter may provide a better grip for the crimped connection.

For a single or massive conductor 15, screwing the contact part to the conductor for initially fixing the two may be particularly useful. It may further provide a temporary fixation of the parts 1,15 such that arranging and crimping the ferrule 13 may be facilitated.

For establishing a relatively large contact area, and thus a relatively low contact resistance, between the crimping section 3 and the conductor 15, the length of the crimping section 3 may be several times the cross section of the conductor. Suitable lengths are between approximately 1 and 10 times the conductor diameter, such as between approximately 2.5 and 7.5 times, e.g. approximately 5 times.

The crimping section 3 and the transition region between the mating section 2 and the crimping section 3 may be formed with relatively much material, such that the cross section of the contact part 1 is relatively large and the inherent resistance of the contact part 1 is kept relatively low. For this, the transition region may be provided with lead-in portions of the barrel-shape of the contact beams 4 out of the plate-like body members 7 of the mating section 2. Such lead-in portions further serve as ribs providing mechanical strength to the contact part 1. The plate- or sheet material may therefore be relatively thin or mechanically weak. Other or additional reinforcement features such as ribs or additional material may also be provided.

Structural integrity and mechanical robustness of the connector contact may be derived from the ferrule 13 holding parts of the contact part 1, here the plate like body members 7, together. Since the ferrule may firmly clasp the body members 7 together, such force need not be provided by a folding area 10 joining plate like body members 7. Similarly, welds or other joints between body members 7 may be left out or be relatively weak. Thus, the contact part need not be designed for establishing mechanical contact to the conductor of a cable, but instead may be optimised for electrical properties and mating to a counter contact. Similarly, the shape of blanks for contact parts may be optimised for base-material use or for tooling constraints.

The present contact design may also be extended with one or more additional crimping sections, e.g. arranged substantially parallel to each other or fanning out in (a segment of) a star-like pattern, such that a plurality of cables or wires may be attached to a single contact. Thus, several power supplies, loads and/or contacts may be efficiently connected.

The contact part need not be unitary; the contact beams and/or the mating section may also be assembled objects from one or more parts. This further increased the flexibility of the design for the connector contact assembly and consequently its optimization.

The contact assembly or a connector comprising such contact assemblies may be provided as a kit of parts for assembling by a user or pre-assembled and mounted to a cable.

A connector, preferably a cable connector, comprising one or more connector contact assemblies according to any one of the claims 1-8 may be used for transmitting high powers without undue heating, yet still be constructed relatively compact and cost-efficient. Substantially all elements may each be optimised for a single aspect, such that previously required trade-offs, e.g. between electrical and mechanical properties, may be prevented to a large extent.

It should be appreciated that the connector contact assembly described above may not only be used for transmitting high power, but also for low power and/or signals. Similarly, non-plate-like mating sections may be used.

1. Connector contact assembly comprising a contact part for establishing electrical contact between a conductor of a cable or wire and a mating counter contact,
the contact part comprising a mating section and a crimping section,
the crimping section comprising a plurality of contact beams extending from the mating section and being arranged for engaging the conductor of the cable or the wire,
the assembly further comprising a crimping ferrule being adapted to be crimped onto at least a portion of the contact beams for fixing the contact part to the conductor.

2. Connector contact assembly according to claim 1, wherein the contact beams form a generally barrel-shaped crimping section.

3. Connector contact assembly according to claim 1, wherein the mating section is plate-like.

4. Connector contact assembly according to claim 3, wherein the mating section is formed as a plate-like body member stacked against a second plate-like body member, wherein a plurality of straight or flat beams and a plurality of bent or angled beams alternatingly extend from each of the body members.

5. Connector contact assembly according to claim 1, wherein the connector contact assembly is arranged for being attached to an insulated cable or wire having an insulating sheath and wherein the crimping ferrule is arranged for also enveloping said insulating sheath.

6. Connector contact assembly comprising a contact part for establishing electrical contact between a conductor of a cable or wire and a mating counter contact the contact part comprising a mating section and a crimping section,
the mating section being plate-like, being formed as a folded plate
the crimping section comprising a plurality of contact beams extending from the mating section and being arranged for engaging the conductor of the cable or the wire,
the assembly further comprising a crimping ferrule being adapted to be crimped onto at least a portion of the contact beams for fixing the contact part to the conductor.

7. Connector contact assembly comprising a contact part for establishing electrical contact between a conductor of a cable or wire and a mating counter contact,
the contact part comprising a mating section and a crimping section,
the mating section being formed as a plate-like body member stacked against a second plate-like body member, wherein a plurality of straight or flat beams and a plurality of bent or angled beams alternatingly extend from each of the body members
the crimping section comprising a plurality of contact beams extending from the mating section and being arranged for engaging the conductor of the cable or the wire,
the assembly further comprising a crimping ferrule being adapted to be crimped onto at least a portion of the contact beams for fixing the contact part to the conductor.

8. Connector comprising one or more connector contact assemblies according to claim 1.

9. Kit of parts for assembling a connector contact assembly according to claim 1.

10. Method for attaching a connector contact assembly onto a conductor of a cable or a wire, comprising the steps of:
providing a contact part comprising a mating section and a crimping section having a plurality of contact beams and
providing a crimping ferrule,
providing an exposed portion of the conductor,
arranging the crimping ferrule around the cable or wire,
arranging the crimping ferrule around at least part of the crimping section of the contact part,
and crimping the crimping ferrule at least onto the exposed portion of the conductor and the crimping section, thereby fixing the conductor and the contact beams mechanically and electrically to each other.

11. Kit of parts for assembling a connector according to claim 8.
